(19) United States
(12) Patent Application Publication
(10) Pub. No.: US 2025/0290240 A1
(43) Pub. Date: Sep. 18, 2025

(54) NONWOVEN TEXTILE AND APPARATUS FOR MAKING SAME

(71) Applicant: REIFENHÄUSER GMBH & CO. KG MASCHINENFABRIK, Troisdorf (DE)

(72) Inventors: Patrick BOHL, Hellef (DE); Andreas ROESNER, Bonn (DE); Tobias WAGNER, Koeln (DE)

(21) Appl. No.: 18/858,802

(22) PCT Filed: Jun. 16, 2023
(86) PCT No.: PCT/EP2023/066239

§ 371 Date: Oct. 22, 2024

(30) Foreign Application Priority Data
Jun. 17, 2022 (DE) 10 2022 115 200.6

(51) Int. Cl. D04H 3/16; D01D 5/22; D04H 3/147

(52) U.S. Cl. CPC D04H 3/16; D01D 5/22; D04H 3/147; D10B 2321/02; D10B 2401/041

(57) ABSTRACT

The invention relates to a nonwoven fabric comprising at least one nonwoven web composed of fibres. The nonwoven fabric has an embossed pattern. The embossed pattern consists of a plurality of embossments—preferably not connected to one another. The embossments each have an embossing area of 0.05 to 0.3 mm².

The invention relates to a nonwoven fabric comprising at least one nonwoven web of filaments, wherein the nonwoven fabric has an embossing pattern consisting of a plurality of preferably not interconnected embossments. Furthermore, the invention relates to an apparatus and a method for making such a nonwoven fabric with at least one nonwoven web of filaments.

Nonwoven fabrics, as well as apparatuses and methods of making nonwoven fabrics of the above-mentioned type are fundamentally known from practice in various embodiments. The filaments made are usually deposited on a receiving device to form the nonwoven web and then preconsolidated in order to ensure the transportability of the nonwoven web or nonwoven fabric and to ensure that the nonwoven web is not displaced or destroyed during transport through the device. For further consolidation, the nonwoven fabric is usually detached from the receiving device and fed, for example, to a calender comprising at least one calender roller, in particular comprising a pair of calender rollers. Calender rollers with embossing elements are frequently used that introduce an embossing pattern comprising a large number of embossments into the nonwoven fabric in the course of the consolidation process. As a result of the known calendering steps a satisfactory consolidation and in particular an advantageous mechanical stability of the resulting nonwoven fabric is achieved. However, the measures known from practice, in which a calender with at least one calender roller comprising embossing elements is used to consolidate the nonwoven fabric, are characterized by the disadvantage that the consolidation measures impair the thickness or volume of the nonwoven fabrics and that, in addition, particularly due to the dimensions of the embossments, an optically perceptible embossing pattern is provided in the nonwoven fabric. Although the embossing pattern is advantageous or necessary with regard to the mechanical properties of the nonwoven fabrics, it is disadvantageous for aesthetic reasons because it adversely affects the visual properties. In addition, the embossing patterns or embossments created using the known methods can be disadvantageous for the further handling or treatment of the nonwoven fabrics.

In view of this, the object of invention is to provide a nonwoven fabric of the above-mentioned type in which the disadvantages described previously can be effectively and reliably avoided and that is characterized in particular by advantageous mechanical properties, for example by a sufficient mechanical strength or surface resistance, as well as by a satisfactory thickness or voluminosity and in which optical impairments can be reduced or largely avoided by an embossing pattern composed of embossments. Furthermore, the object of the invention is to provide an apparatus and a method of making such a nonwoven fabric.

To attain this object, the invention teaches a nonwoven fabric comprising at least one nonwoven web of filaments, wherein the nonwoven fabric has an embossing pattern consisting of a plurality of—preferably not interconnected—embossments, wherein the embossments each have an embossing area of 0.05 to 0.3 mm², preferably of 0.06 to 0.2 mm², preferably of 0.07 to 0.18 mm², particularly preferably of 0.08 to 0.15 mm² and quite particularly preferably of 0.09 to 0.12 mm². It is within the scope of the invention that the embossments each have an embossing area of less than 0.3 mm², preferably less than 0.2 mm², preferably less than 0.18 mm², particularly preferably less than 0.15 mm², quite particularly preferably less than 0.12 mm², for example less than 0.1 mm².

In the context of the invention, the term “embossing” means in particular a compacted location of the nonwoven fabric where the nonwoven fabric has a smaller thickness in comparison to its nonembossed regions and where the filaments of the nonwoven fabric are at least partially connected or fused to one another, preferably by the action of pressure and/or temperature. The embossments of the embossing pattern according to the invention are preferably made by at least one calender roller with a complementary embossing pattern of embossing elements. This is explained in more detail hereinafter.

In the context of the invention, the term “embossing pattern” means in particular the pattern resulting from the plurality of embossments of the nonwoven fabric. The embossing pattern can be a regular and/or an irregular embossing pattern. It is preferred that the embossing pattern is a regular embossing pattern. Then the individual embossments are preferably distributed at regular spacings, preferably at identical spacings, on the nonwoven fabric. Further preferably, the embossing area of the individual embossments of the embossing pattern according to a preferred embodiment of the invention is the same size or substantially the same size. It has proven to be beneficial that the geometry of the embossing areas of the individual embossments is identical or substantially identical. Quite particularly preferably, the embossing pattern has the same or the same size embossments or substantially the same or the same size embossments with a homogeneous distribution of embossments having the same geometry or substantially the same geometry. In principle however, it is also possible that the individual embossments of the embossing pattern have a have a different size and/or a different geometry and/or that the embossments are in an irregular embossing pattern on the nonwoven fabric. In the context of the invention, “geometry of the embossments” means in particular the geometry of the embossing areas of the embossments in plan view.

In the context of the invention, the “embossing area of an embossing” means in particular the embossed area of an embossment, whereby when determining the size of the embossing area, any material overhang or material projection that may have formed in the course of the pressing or embossing process and that at least partially surrounds the embossment is in particular not part of the embossing area of an embossment. In the case of an embossment or an embossing area with a punctuate or circular geometry in plan view, the embossing area of the embossment corresponds, for example, to the area of the punctuate or circular embossment, whereby the material overhang or the material projection possibly surrounding the embossment is not included in the embossing area of the embossment. The fact that the embossments of the nonwoven fabric according to the invention each have an embossing area in the above-specified range means in particular within the scope of the invention that at least 95%, preferably at least 97% of all embossments of the nonwoven fabric have an embossing area in the specified range. Particularly preferably, all the embossments of the nonwoven fabric have an embossing area in the specified range. Within the scope of the invention, the embossing area of an embossment can be determined in particular by incident light or transmitted light 2D microscopy, and/or by scanning electron microscopy (SEM) and/or by microcomputer tomography (CT). In the corresponding image evaluation, preferably a geometry underlying the embossing area geometry or corresponding or substantially corresponding to the embossing area geometry is used as a basis and placed over the individual optically imaged embossing areas of the embossments for evaluation.

The fact that the nonwoven fabric comprises at least one nonwoven web of filaments means in particular within the scope of the invention that the nonwoven fabric comprises at least one nonwoven web or nonwoven layer composed of made and deposited filaments. According to one embodiment, the nonwoven fabric can comprise only one nonwoven web or one nonwoven layer or can also comprise several nonwoven webs or nonwoven layers one above the other that are combined to form the nonwoven laminate. This is explained in more detail hereinafter.

The invention has recognized that due to the embossments of the nonwoven fabric according to the invention with the special size of the embossing areas a nonwoven fabric can be provided in which visual impairments caused by the embossing pattern of embossments can be almost completely avoided due to the at least significantly reduced perceptibility of the embossing pattern for the human eye and that is nevertheless characterized by advantageous mechanical properties and a satisfactory thickness.

A particularly preferred embodiment of the invention is characterized in that the embossing pattern is an invisible or substantially invisible embossing pattern, in which the embossments are configured to be invisible or substantially invisible embossments. In this context, “invisible” means in particular that the embossing pattern of the nonwoven fabric or the embossments of the nonwoven fabric is/are not perceptible to the human eye or is/are substantially not perceptible.

It is within the scope of the invention that the smallest spacing d between two embossments of the embossing pattern is in each case 0.6 to 2.5 mm, preferably 0.8 to 2.0 mm, more preferably 0.9 to 1.8 mm, particularly preferably 0.95 to 1.6 mm and quite particularly preferably 1.0 to 1.5 mm. Expediently, the smallest spacing d between two embossments of the embossing pattern is at least 0.6 mm, in particular at least 0.8 mm, preferably at least 1.0 mm, particularly preferably at least 1.4 mm and quite particularly preferably at least 2.0 mm. “Smallest spacing d between two embossments of the embossing pattern” means in particular the smallest spacing d between two immediately adjacent embossments of the embossing pattern, i.e. preferably the smallest spacing between one embossment and the embossment of the embossing pattern that is closest to it. Furthermore, the smallest spacing d between two embossments of the embossing pattern refers in particular to the smallest spacing between the embossing boundaries of two embossments, i.e. to the smallest spacing between the two embossments along the interposed nonembossed area of the nonwoven fabric. This embodiment is based on the discovery that the optical perceptibility of the embossing pattern comprising embossments can be further reduced, while nevertheless ensuring advantageous mechanical properties and a sufficient thickness of the nonwoven fabric. The previously described smallest spacing between two embossments of the embossing pattern preferably refers to at least 95%, preferably to at least 97% of all the embossments of the nonwoven fabric. Particularly preferably, the described smallest spacing between two embossments refers to all the embossments of the nonwoven fabric.

According to a particularly preferred embodiment of the nonwoven fabric according to the invention, the proportion of the total embossing area of the embossing pattern to the total surface area of the nonwoven fabric is 2 to 12%, preferably 2.5 to 8%, preferably 3 to 6%, particularly preferably 3.5 to 5.5% and quite particularly preferably 4 to 5%. It is within the scope of the invention that the proportion of the total embossing area of the embossing pattern to the total surface area of the nonwoven fabric is less than 10%, preferably less than 8%, more preferably less than 6.5%, more preferably less than 5.5% and quite particularly preferably less than 5%. Due to this proportion of the total embossing area of the embossing pattern to the total surface area of the nonwoven fabric the visual perceptibility of the embossing pattern comprising embossments can be further reduced. Nevertheless, a nonwoven fabric with satisfactory mechanical properties results. In this context, “the total embossing area of the embossing pattern” means in particular the sum of all the embossing areas of the embossing pattern. In the context of the invention, “the total surface area of the nonwoven fabric” means in particular the entire nonwoven fabric surface area including the embossed and nonembossed regions.

It is recommended that the embossing areas of the embossments in plan view have at least one geometry selected from the group: “punctuate or circular, elliptical, square, rectangular, diamond-shaped, polygonal, linear, wavy”. As has already been described above, “the embossing area” of an embossing means in particular the embossed area of an embossment without the material overhang or the material projection possibly surrounding the embossing area. It is preferred that the embossing areas or the embossments of the embossing pattern each have the same or substantially the same geometry. In principle, however, it is also within the scope of the invention that the embossing pattern has embossing areas or embossments of different geometries. A particularly preferred embodiment of the invention is characterized in that the embossing areas of the embossments or of all embossments are punctuate or circular in plan view.

It is further within the scope of the invention that the aspect ratio of the embossing area of the embossments is in each case less than 4, preferably less than 3, particularly preferably less than 2, for example equal to 1. In this context, “aspect ratio” of the embossing area means in particular the ratio of the greatest length or longitudinal extension of the embossing area of an embossment to the greatest width or width extension of the embossing area of the embossment and, for example, the ratio of the lengths of the axes of symmetry. For example, in the case of a punctuate or circular geometry of the embossing area of an embossment in plan view, the aspect ratio is equal to 1. In the case of an elliptical geometry of the embossing area of an embossment in plan view, the aspect ratio corresponds, for example, to the ratio of the length of the major axis or major semi-axis to the length of the minor axis or minor semi-axis of the ellipse. In the case of a rectangular geometry of the embossing area of an embossment in plan view, for example, the aspect ratio corresponds to the ratio of the length of the rectangle to the width of the rectangle. In the case of a diamond-shaped geometry of the embossing area of an embossment in plan view, for example, the aspect ratio corresponds to the ratio of the length of the longer diagonals to the length of the shorter diagonals of the diamond. In the case of a square geometry of the embossing area of an embossment in plan view, the aspect ratio is equal to 1. For curved lines, the aspect ratio of the enclosing rectangle preferably describes the aspect ratio of the embossing area.

It is fundamentally within the scope of the invention that the filaments of the at least one nonwoven web are short filaments or that the at least one nonwoven web contains short filaments. According to a preferred embodiment, the filaments of the at least one nonwoven web are continuous filaments. Particularly preferably, the filaments of all the nonwoven webs of the nonwoven fabric are continuous filaments. Continuous filaments differ due to their virtually endless length from short filaments that have significantly shorter lengths of for example 1 mm to 60 mm.

As described hereinbefore, according to a particularly preferred embodiment of the invention, the filaments of the at least one nonwoven web are formed as continuous filaments. Preferably, the filaments of the at least one nonwoven web or at least one nonwoven web of the nonwoven fabric are formed as continuous filaments made of at least one thermoplastic material, preferably of at least one polyolefin. In the case of the at least one polyolefin it is recommended that this is polypropylene and/or polyethylene. In principle, the continuous filaments can also be made from other thermoplastics such as polyesters, for example polyethylene terephthalate (PET) and/or polylactide (PLA), as well as from mixtures of the above-said thermoplastic materials. According to one embodiment, copolymers of the said thermoplastic materials are used. Common additives such as plasticizers, fillers, dyes and the like can be added to said thermoplastic materials. It is within the scope of the invention that the continuous filaments of the at least one nonwoven web or at least one nonwoven web of the nonwoven fabric are made as spunbonded continuous filaments. In principle, it is also possible that the continuous filaments of at least one nonwoven web or nonwoven web of the nonwoven fabric are made as meltblown continuous filaments.

According to a particularly preferred embodiment of the invention, the filaments of the at least one nonwoven web are formed as crimped continuous filaments, wherein the crimped continuous filaments are preferably multicomponent filaments, particularly preferably bicomponent filaments.

In this context, it has proven particularly useful that the multicomponent filaments or bicomponent filaments comprise a first component that consists or substantially consists of at least one thermoplastic material, in particular of at least one polyolefin, preferably of polyethylene and/or of polypropylene and/or that the multicomponent filaments or bicomponent filaments comprise a second or further component that consists or substantially consists of at least one thermoplastic material, in particular of at least one polyester and/or polypropylene. Polyethylene terephthalate (PET) and/or polylactide (PLA) are particularly suitable as polyesters. According to one embodiment, copolymers of these plastics are used. When it is stated here or below with reference to the components of the multicomponent filaments or the bicomponent filaments and in particular with reference to a plastic or a polymer that this “substantially consists of”, this means in particular that the component or the polymer is provided to an extent of at least 95% by weight, preferably to an extent of at least 97% by weight and preferably to an extent of at least 98% by weight. The remaining percentage by weight can be formed in particular by additives such as plasticizers, fillers, dyes and the like.

According to a preferred embodiment of the invention, the first component of the multicomponent filaments or the bicomponent filaments is formed on the basis of polyethylene and preferably consists of polyethylene or substantially of polyethylene. According to a further preferred embodiment, the first component of the multicomponent filaments or bicomponent filaments is formed on the basis of polypropylene and preferably consists of polypropylene or substantially of polypropylene. Instead of polypropylene or in addition to polypropylene, at least one polypropylene copolymer can also be used within the scope of the invention.

The second or further component of the multicomponent filaments or bicomponent filaments according to a preferred embodiment of the invention is formed on the basis of at least one polyester and/or on the basis of polypropylene. Particularly preferably, the second or further component of the multicomponent filaments or bicomponent filaments consists of at least one polyester and/or polypropylene. For the second or further component, at least one polypropylene copolymer can be used instead of polypropylene or in addition to polypropylene and preferably at least one polyester copolymer can be used instead of the polyester or in addition to the polyester. Expediently polyethylene terephthalate (PET) and/or polylactide (PLA) are particularly suitable as polyesters, and a PET copolymer (co-PET) is particularly suitable as polyester copolymer. It is also within the scope of the invention that a polylactide copolymer (co-PLA) is used as the first component and polylactide (PLA) is used as the second or further component.

It is within the scope of the invention that the continuous filaments, preferably the crimped continuous filaments, are multicomponent filaments or bicomponent filaments with side-by-side configuration and/or with core-sheath configuration, in particular with eccentric core-sheath configuration, and preferably the first component described previously is the sheath component and expediently the second or further component described previously is the core component. If the continuous filaments are multicomponent filaments or bicomponent filaments with core-sheath configuration, it is also possible within the scope of the invention that this is a centric core-sheath configuration.

If the continuous filaments or the crimped continuous filaments according to the preferred embodiment are multicomponent filaments or bicomponent filaments with eccentric core-sheath configuration, it is within the scope of the invention that both the sheath of the filaments and the core of the filaments—seen in the filament cross-section—is configured to be circular. According to a further preferred embodiment of the invention, the multicomponent filaments or bicomponent filaments are multicomponent filaments or bicomponent filaments with an eccentric core-sheath configuration and the core of these filaments—seen in the filament cross-section—is configured to be circular segment-shaped and has a circular arc-shaped circumferential section as well as a linear circumferential section with respect to its circumference, so that a D-shape of the core—seen in the filament cross-section, results.

If the continuous filaments or the crimped continuous filaments are multicomponent filaments or bicomponent filaments with at least one first component described previously and at least one second or further component described previously, it is preferred that the first component is a lower-melting component compared to the second component. The first or lower-melting component is preferably polyethylene and/or polypropylene, in particular polyethylene. According to a preferred embodiment, the proportion of the lower-melting first component of the multicomponent filaments or bicomponent filaments of the at least one nonwoven web of the nonwoven fabric is 20 to 80 wt. %, preferably 25 to 65 wt. %, more preferably 30 to 50 wt. %, relative to the components of the multicomponent filaments or bicomponent filaments. The lower-melting component or the lower-melting first component of the multicomponent filaments or bicomponent filaments is in the context of the invention, in particular a binder component for the multicomponent filaments or bicomponent filaments.

According to a particularly preferred embodiment of the nonwoven fabric according to the invention, the titre of the filaments of the nonwoven fabric, in particular of the continuous filaments or the crimped continuous filaments, is 0.5 to 6.0 den, preferably 0.8 to 5.0 den, particularly preferably 1.0 to 2.5 den.

A recommended embodiment of the invention is characterized in that the nonwoven fabric has a mass per unit area of less than 200 g/m², in particular of less than 150 g/m², preferably of less than 100 g/m², preferably of less than 75 g/m², particularly preferably of less than 50 g/m², and quite particularly preferably of less than 30 g/m². It is particularly preferred that the mass per unit area of the nonwoven fabric is 10 g/m² to 80 g/m², preferably 15 g/m² to 60 g/m², preferably 15 g/m² to 30 g/m².

It is very preferred that the nonwoven fabric has a thickness h of 0.1 to 0.85 mm, preferably of 0.15 to 0.75 mm, preferably of 0.2 to 0.65 mm, particularly preferably of 0.25 to 0.55 mm. It is within the scope of the invention that the nonwoven fabric has a thickness h of at least 0.4 mm, in particular of at least 0.5 mm, preferably of at least 0.55 mm, preferably of at least 0.6 mm, particularly preferably of at least 0.625 mm. “Thickness h” means the greatest thickness or total thickness of the nonwoven fabric transversely, in particular perpendicularly or substantially perpendicularly to its planar extension in the nonembossed regions of the nonwoven fabric. The thickness or the total thickness h of the nonwoven fabric is measured according to the method WRT 120.6(05)—Option A.

A very well-proven embodiment of the invention is characterized in that the nonwoven fabric has an abrasion resistance of at least Class 2 according to Martindale, preferably Class 1 according to Martindale and/or that the nonwoven fabric has a maximum flexural stiffness with a cantilever of at most 100 mm, preferably of at most 90 mm, preferably of at most 80 mm, particularly preferably of at most 75 mm and quite particularly preferably of at most 70 mm. This embodiment is based on the discovery that the nonwoven fabric is then characterized by a very satisfactory abrasion resistance and/or that the nonwoven fabric has an advantageously low flexural stiffness and, in particular, also has an improved drapability compared to the known measures or nonwoven fabrics. These properties in the nonwoven fabric according to the invention in particular result in an advantageous combination with a satisfactory mechanical strength and an at least significantly reduced visual perceptibility of the embossing pattern of embossments. The abrasion resistance of the nonwoven fabric is determined within the scope of the invention in particular with a Martindale abrasion tester according to the following test method:

In particular the “SDL Atlas M235 Martindale Tester” is used as the test device. The procedure for determining the abrasion resistance is preferably based on WSP20.5(05), wherein the following deviations from WSP20.5(05) are provided in particular: the surface (top/bottom) is tested separately; at least 10, preferably at least 20 tests are carried out per sample and surface, wherein the test specimens are taken uniformly from the area of the sample, the final result being the arithmetic mean. The test specimens are to be obtained from a representative position, for example not just from the edge, since the test or the deviations in the result should not be influenced by macroscopic deviations, such as poor process control, but only by typical (local) fluctuations; the tested sample is stretched on standard felt and mounted in the lower holder; the same nonwoven fabric is used as the moving upper friction surface with the side to be tested against each other; this piece is attached together with the PU foam patch (e.g. from SDL Atlas); 9 kPa contact pressure; 32 cycles, i.e. two full rounds of the Lissajous figure; after each of the tests the pair (test specimen and upper friction surface) is exchanged;

the samples are rated from 1 to 5, with 1 being the best rating. For example, if the mean is 1 on the top and 3 on the bottom, the sample is rated 1 overall. Only the changes in the nonwoven are evaluated; if the nonwoven previously showed similar defects, these can be overlooked. This means strands of filaments, groups or bundles of filaments on the surface. If a test specimen clearly exhibits these defects from the outset, the test specimen should be excluded in case of doubt.

Grade 1: Virtually no change when viewed from above. The surface may be slightly loosened, but the filaments may only loosen and not form larger or longer clumps. When viewed from the side, the pile height of the loose filaments must not exceed 5 mm. Individual filaments or filaments may be pushed together to form a small ball <2 mm in diameter.

Grade 2: in addition to the above damage pattern (Grade 1): Filaments are loosened and matted with neighboring filaments to form an elongated agglomerate. These groups of filaments are called “strands” or “strings or bundles”. These strands are 5 to 40 mm long and are connected to the substrate at least every 10 mm. A strand is max. 5 mm high (5 mm above the surface) and max. 2 mm wide.

Grade 3: The above “strands” are no longer connected to the substrate along their length, possible connections are >10 mm apart or the strands here are only connected to the specimen at the start and end point. It is possible to lift and move these strands e.g. with a needle.

Grade 4: The strands are connected to neighboring strands to form a network. “Spider web”.

Grade 5: The sample is further destroyed, first hole formation has occurred.

Within the scope of the invention, the flexural stiffness of the nonwoven fabric is determined in particular according to the method “WSP 90.1(05) Standard Test Method for Stiffness of Nonwoven: Fabrics Using the Cantilever Test”.

It is within the scope of the invention that the strength of the nonwoven fabric in the machine direction (MD direction) is at least 8 N/5 cm, in particular at least 10 N/5 cm, preferably at least 15 N/5 cm, preferably at least 17.5 N/5 cm, particularly preferably at least 20 N/5 cm, quite particularly preferably at least 22.5 N/5 cm. In the context of the invention, “machine direction (MD direction) means in particular the travel direction F of the nonwoven fabric on the receiving device. The strength of the nonwoven fabric in the machine direction is determined within the scope of the invention in particular according to the following method: “Determination of tensile strength (based on Edana 20.2-89)”: in N/5 cm; with 50 mm sample width; 100 mm clamping length; 200 mm/min test speed.

According to a particularly preferred embodiment of the invention, the depth t of the embossments is 0.1 to 0.8 mm, preferably 0.15 to 0.7 mm, particularly preferably 0.2 to 0.6 mm, quite particularly preferably 0.25 to 0.5 mm. “Depth t of the embossments” means in particular the difference in thickness between the thickness or total thickness h of the nonwoven fabric and the thickness of the nonwoven fabric in the region of the embossing area of an embossment. The total thickness h of the nonwoven fabric is determined in particular according to the method described above. The thickness of the nonwoven fabric in the region of the embossing area of an embossment can be determined within the scope of the invention, for example, by optical or microscopic analysis of a cross-section of the nonwoven fabric. This is possible, for example, by pouring a sample with a cross-section through the embossing point and polishing the cut surface. In this cut surface, the thickness of the embossing area can then be determined from the side using a typical microscope. In the case of lighter mass per unit areas, the embossing area can be porous; in this case, it is then preferable to determine the thickness only in the formed sections. Additionally or alternatively, a microcomputer tomography (CT) scan is suitable, which allows the determination of the average thickness of the embossing area.

It is within the scope of the invention that the nonwoven fabric only comprises one nonwoven web or only one nonwoven fabric layer. The nonwoven web or nonwoven layer can, for example, comprise one nonwoven web of continuous filaments, in particular of crimped continuous filaments. According to a preferred embodiment, the nonwoven fabric is a nonwoven laminate composed of at least two, in particular of at least two nonwoven webs or previously described nonwoven fabric layers. It is preferred that the filaments of the at least two nonwoven webs or nonwoven fabric layers, in particular the filaments of all the nonwoven webs or nonwoven fabric layers of the nonwoven fabric are continuous filaments or crimped continuous filaments. In principle, the nonwoven fabric can also comprise nonwoven webs or nonwoven fabric layers with filaments made of noncrimped continuous filaments or short filaments. It has proven to be beneficial that the filaments of at least one nonwoven web or nonwoven web layer associated with an outer surface of the nonwoven fabric are crimped continuous filaments and/or short filaments. As a result, in particular the softness of the nonwoven fabric can be improved and the flexural stiffness can be reduced. It is also possible that the properties of the filaments or continuous filaments of the various nonwoven webs or nonwoven fabric layers of the nonwoven fabric differ. For example, the continuous filaments of a first nonwoven web can have a lower average titre than the continuous filaments of a second nonwoven web, resulting in a titre gradient.

According to a preferred embodiment of the invention, the nonwoven fabric is a spunbonded nonwoven fabric comprising at least one spunbonded nonwoven web or comprising at least one spunbonded nonwoven layer. It is possible that the nonwoven fabric is a nonwoven laminate of at least two spunbonded nonwoven webs or at least two spunbonded nonwoven fabric layers. However, it is also possible that the nonwoven laminate comprises at least one meltblown nonwoven layer or meltblown nonwoven web. It is further within the scope of the invention that the nonwoven fabric is a nonwoven laminate composed of at least three, for example at least four nonwoven webs or nonwoven fabric layers. The individual nonwoven webs or nonwoven fabric layers can be either spunbonded nonwoven webs or nonwoven fabric layers. In principle however, the nonwoven laminate could also comprise at least a meltblown nonwoven web or meltblown nonwoven fabric layer. The spunbonded nonwoven webs or the spunbonded nonwoven fabric layers are preferably each formed from continuous filaments or crimped continuous filaments.

A proven embodiment of the invention is characterized in that the nonwoven fabric is consolidated with at least one calender roller of making the embossing pattern and preferably with at least one hot-fluid main consolidater, in particular with at least one hot-air main consolidater. The at least one calender roller is preferably part of a calender that preferably comprises at least two calender rollers or at least one pair of calender rollers. If the nonwoven fabric is consolidated according to a preferred embodiment with at least one calender roller of making the embossing pattern and with at least one hot-fluid main consolidater, this results in particular in a nonwoven fabric that is characterized by advantageous optical properties, a particularly advantageous mechanical strength and at the same time by an advantageously low flexural stiffness and a satisfactory abrasion resistance.

In the context of the invention, the term “hot fluid” means a temperature-controlled or heated fluid. The hot fluid is preferably a temperature-controlled or heated gas and particularly preferably hot air. In principle, the hot fluid can also be a temperature-controlled or heated liquid, for example water.

The invention also relates to the use of a nonwoven fabric described previously for at least one hygiene product or in at least one hygiene article.

To attain this object, the invention further teaches an apparatus for making a nonwoven fabric comprising at least one nonwoven web of filaments, in particular of making a nonwoven fabric described previously, wherein the device comprises at least one filament-making device, in particular at least one spinning beam, and at least one receiving device, in particular at least one foraminous belt, for depositing the filaments to form the nonwoven web and wherein furthermore at least one calender roller is provided for introducing an embossing pattern comprising a plurality of embossments into the nonwoven fabric, wherein the calender roller has a complementary embossing pattern of embossing elements, wherein the embossing elements each have a pressing area of 0.05 to 0.3 mm², preferably of 0.06 to 0.2 mm², more preferably of 0.07 to 0.18 mm², particularly preferably of 0.08 to 0.15 mm² and most preferably of 0.09 to 0.12 mm².

It is within the scope of the invention that the embossing elements of the complementary embossing pattern of the at least one calender roller each have an embossing height in the range of 0.3 to 1.2 mm, preferably of 0.4 to 0.9 mm, particularly preferably of 0.5 mm to 0.8 mm. “Embossing height” means in particular the height difference between the pressing area of an embossing element and the base of the calender roller. This embodiment is based on the discovery that during a calendering process with such a calender roller, compaction of the nonwoven fabric can be at least largely minimized.

Conveniently, the foraminous belt of the device according to the invention is an endlessly rotating foraminous belt. It is within the scope of the invention that the calender roller is part of a calender. The calender is preferably downstream of the receiving device or the foraminous belt in the travel direction F of the nonwoven fabric. According to a particularly preferred embodiment, the calender comprises at least one pair of calender rollers and at least one, in particular one, of the two calender rollers of the calender or of the pair of calender rollers is a calender roller described previously for introducing an embossing pattern of embossments into the nonwoven fabric. The other or further roller of the calender or pair of calender rollers is expediently a smooth roller with a smooth outer surface. Preferably, within the scope of the invention, the nonwoven fabric is thus consolidated using a calender that comprises at least one calender roller described previously for introducing an embossing pattern comprising a plurality of embossments into the nonwoven fabric and at least one smooth roller. Then the embossing pattern is preferably introduced into the nonwoven fabric from only one side of the nonwoven fabric. Preferably, however, the embossing pattern is nevertheless present in the resulting nonwoven fabric on both nonwoven fabric sides, with the embossing depth being distributed differently on the two nonwoven fabric sides.

In the context of the invention, “pressing area” means in particular the area of the embossing elements of the calender roller provided of making the embossing area of the embossments. If the embossing elements of the calender roller are configured, for example, as cylindrical embossing elements to produce an embossing area with a punctuate or circular geometry in plan view, the pressing area of the embossing elements corresponds in particular to the area of the cylinder top side. If the embossing elements of the calender roller are configured to produce an embossment with an embossing area having a punctuate or circular geometry in plan view, for example in the shape of a truncated cone, i.e. with a flank angle, the pressing area of the embossing elements corresponds in particular to the top surface of the truncated cone. One embodiment of the invention uses several flank angles for the embossing elements, wherein the embossing elements preferably have smaller flank angles in the region intended for contact with the nonwoven fabric than further towards the base of the calender roller. The flank angle gradation can be accomplished stepwise or continuously.

The at least one calender roller for introducing an embossing pattern comprising a plurality of embossments into the nonwoven fabric is within the scope of the invention preferably configured with the proviso that the properties of the embossments described above, in particular with regard to the embossing area and/or with regard to the smallest spacing d between two embossments and/or with regard to the depth t of the embossments and/or with regard to the proportion of the total embossing area of the embossing pattern to the total surface area of the nonwoven fabric and/or with regard to the aspect ratio of the embossing area of the embossments can thereby be realized.

It is within the scope of the invention that the at least one filament-making device or the at least one spinning beam is configured to produce a spunbonded nonwoven web from continuous filaments, in particular from crimped continuous filaments. If the nonwoven fabric according to one embodiment of the invention is a nonwoven laminate comprising at least two nonwoven fabric layers or nonwoven webs, it is within the scope of the invention that at least two filament-making devices, in particular at least two spinning beams, are present and that preferably all filament-making devices or spinning beams are designed of making spunbonded nonwoven webs from continuous filaments, in particular from crimped continuous filaments. Quite particularly preferably, the at least one filament-making device or the at least one spinning beam, preferably all the filament-making devices or all the spinning beams of the device according to the invention, are adapted to produce multicomponent filaments or bicomponent filaments. It is further within the scope of the invention that the device is configured to produce at least one nonwoven web from crimped continuous filaments. Preferably, at least one filament-making device or at least one spinning beam is adapted to produce crimped continuous filaments. When using several spinning beams for the device according to the invention, at least one spinning beam or at least two spinning beams or all the spinning beams are adapted for the production of crimped continuous filaments.

A very expedient embodiment of the invention is characterized in that for the filaments or continuous filaments spun with at least one filament-making device or with at least one spinning beam, at least one cooler for cooling the filaments or filaments and at least one stretcher adjoining the cooler for stretching the filaments or filaments is provided. Advantageously, at least one diffuser adjoins the stretcher in the travel direction of the filaments or filaments. A highly recommended embodiment of the invention is characterized in that the subassembly comprising the cooler and the stretcher is a closed unit and that no further air is supplied from outside to this subassembly apart from the supply of cooling air in the cooler. Expediently the filaments or filaments leaving the diffuser are deposited directly on the receiving device or on the foraminous belt.

A particularly preferred embodiment of the device according to the invention is characterized in that the device has at least one hot-fluid main consolidater, in particular a hot-air main consolidater, wherein the hot-fluid main consolidater is preferably downstream of the calender roller in the travel direction F of the nonwoven fabric. The at least one hot-fluid main consolidater is thus, according to a preferred embodiment, in the travel direction F of the nonwoven fabric downstream of the calender roller according to the invention for introducing an embossing pattern of embossments into the nonwoven fabric and in particular downstream of a calender comprising this calender roller. The hot-fluid main consolidater or the hot-air main consolidater can in particular be a hot-air oven for consolidation or main consolidation of the nonwoven fabric.

It has proven particularly useful within the scope of the invention that the at least one hot-fluid main consolidater or the at least one hot-air main consolidater is a hot-air oven, particularly preferably as an omega oven and/or as a multidrum oven and/or as a single belt oven and/or as a double belt oven. Expediently the consolidation or main consolidation is accomplished with the at least one hot-fluid main consolidater by applying at least one hot fluid to the nonwoven fabric on one side or both sides in the at least one hot-fluid main consolidater. When the hot-fluid main consolidater, especially the hot-air main consolidater, according to a preferred embodiment, is a hot-air oven, then within the scope of the invention the fluid temperature also corresponds in particular to the temperature of the hot air during this hot-air consolidation in the hot-air oven. In principle, the at least one hot-fluid main consolidater can also be in the travel direction F of the nonwoven fabric upstream of the calender roller or a calender comprising the calender roller.

It has proven useful that the device has at least one preconsolidater, in particular at least one hot-fluid preconsolidater, preferably at least one hot-air preconsolidater, wherein the preconsolidater is particularly preferably in the travel direction F of the nonwoven fabric upstream of the calender roller, in particular upstream of a calender or pair of calender rollers comprising the calender roller, and quite particularly preferably is provided downstream or immediately downstream of the at least one filament-making device or at least one spinning beam. Preferably, the at least one preconsolidater is then in the travel direction F of the nonwoven fabric also upstream of the preferably provided hot-fluid main consolidater.

It is within the scope of the invention that the preconsolidater or the hot-fluid preconsolidater is provided above the receiving device or the foraminous belt. It is also within the scope of the invention that the at least one hot-air preconsolidater is configured in the form of at least one hot-air knife and/or in the form of at least one hot-air field. In principle, the preconsolidater can also comprise at least one roller or one smooth roller, in particular a pair of rollers or pair of smooth rollers. If the device according to the invention has at least two filament-making devices or at least two spinning beams, it is within the scope of the invention that at least one preconsolidater, in particular at least one hot-fluid preconsolidater or hot-air preconsolidater is provided downstream or immediately downstream of each filament-making device or each of the spinning beams in the travel direction F of the nonwoven fabric and that the hot-air preconsolidaters are expediently each configured in the form of a hot-air knife and/or in the form of a hot-air field. If the nonwoven fabric according to one embodiment is made with only one nonwoven web, it is preferred that a hot-air knife is used as the preconsolidater. If the nonwoven fabric according to the preferred embodiment is made with several nonwoven webs or nonwoven layers a hot-air knife is preferably used as a preconsolidater for the uppermost or last-deposited nonwoven fabric layer and in particular a hot-air knife and a hot-air field are used as a preconsolidater for the remaining nonwoven webs or nonwoven fabric layers.

To attain this object, the invention further teaches a method of making a nonwoven fabric comprising at least one nonwoven web of filaments, in particular of making a nonwoven fabric described previously and/or with a device described previously, wherein filaments are made with at least one filament-making device, in particular with at least one spinning beam, wherein the filaments are then deposited on at least one receiving device, in particular on at least one foraminous belt, to form the nonwoven web, wherein the nonwoven web or the nonwoven fabric is then consolidated with at least one calender roller and wherein an embossing pattern composed of a plurality of embossments is introduced into the nonwoven fabric by the calender roller, wherein the embossments each have an embossing area of 0.05 to 0.3 mm², preferably of 0.06 to 0.2 mm², preferably of 0.07 to 0.18 mm², particularly preferably of 0.08 to 0.15 mm² and quite particularly preferably of 0.09 to 0.12 mm².

It is within the scope of the method according to the invention that the nonwoven fabric, preferably following the consolidation with the at least one calender roller, in particular with at least one calender or pair of calender rollers comprising the calender roller, is consolidated, in particular main consolidated, with at least one hot-fluid main consolidater, in particular with at least one hot-air main consolidater.

According to a preferred embodiment of the method according to the invention, after being deposited on the receiving device, in particular on the foraminous belt, the nonwoven fabric is firstly preconsolidated with at least one preconsolidater, in particular with at least one hot-fluid preconsolidater, preferably with at least one hot-air preconsolidater, preferably subsequently consolidated with the at least one calender roller according to the invention and subsequently consolidated, in particular main-consolidated with a hot-fluid main consolidater or hot-air main consolidater. It is also possible that after the preconsolidation the nonwoven fabric is first consolidated or preconsolidated with a hot-fluid main consolidater and is then consolidated with the at least one calender roller according to the invention. In the context of the invention, “preconsolidation” means in particular a consolidation of the nonwoven fabric or a nonwoven web, which ensures transportability, but preferably leads to a lower degree of consolidation of the nonwoven fabric than a consolidation or main consolidation.

If, according to a preferred embodiment, a nonwoven fabric comprising at least two nonwoven webs or nonwoven fabric layers is made or if a device with at least two filament-making devices or with at least two spinning beams is provided, a first nonwoven web is preferably first made by the at least one first spinning beam and deposited on the receiving device, in particular on the foraminous belt, and in particular is preconsolidated with a first preconsolidater or hot-fluid preconsolidater. Preferably, a second nonwoven web that is made by the second filament-making device or the second spinning beam, is then deposited on the first nonwoven web and the second nonwoven web or the aggregate composed of the first nonwoven web and the second nonwoven web is then preconsolidated with at least one further preconsolidater or hot-fluid preconsolidater. Preferably, the nonwoven fabric is then detached from the receiving device and fed to a calender having at least one calender roller according to the invention or described previously. The calender roller of the calender expediently introduces an embossing pattern consisting of a plurality of embossments introduced into the nonwoven fabric and the nonwoven fabric is preferably consolidated in the process. The nonwoven fabric is then expediently consolidated by a hot-fluid main consolidater or hot-air main consolidater.

It is within the scope of the invention that the surface temperature of the at least one calender roller, in particular of the calender or pair of calender rollers comprising the calender roller, is higher, in particular by 1° C. to 15° C., preferably by 1° C. to 5° C. higher, than the temperature of the hot fluid of the at least one hot-fluid main consolidater or is lower than the temperature of the hot fluid of the at least one hot-fluid main consolidater or is identical or substantially identical to the temperature of the hot fluid of the at least one hot-fluid main consolidater. Within the scope of the invention, the at least one calender roller, in particular the at least one calender or pair of calender rollers comprising the calender roller, is preferably a pair of heated calender rollers or a heated calender.

It is also possible within the scope of the invention that the fluid temperature of the at least one hot-fluid main consolidater in relation to the melting point Tm of a previously described first, lower-melting component of the multicomponent filaments or bicomponent filaments is in a range from Tm−5° C. to Tm+10° C., wherein the melting temperature Tm of the first, lower-melting component is determined in particular by dynamic differential scanning calorimetry (DSC) according to ISO 11357-3:2011.

The invention is based on the discovery that the nonwoven fabric according to the invention is characterized by an embossing pattern of embossments that can almost completely avoid visual impairments of the nonwoven fabric. Due to the special configuration of the embossments and the properties of the nonwoven fabric, the perceptibility of the embossing pattern to the human eye is at least significantly reduced, so that an almost invisible embossing pattern of embossments results. This is achieved according to the invention in particular by the relatively small embossing area of the embossments. The preferably provided smallest spacing between each two embossments of the embossing pattern and the proportion of the total embossing area of the embossing pattern to the total surface area of the nonwoven fabric also advantageously contribute to the at least significantly reduced perceptibility of the embossing pattern for the human eye. Nevertheless, the nonwoven fabric is characterized by advantageous mechanical properties and a satisfactory thickness. According to a preferred embodiment of the invention, the nonwoven fabric also has very high abrasion resistance and low flexural stiffness. It must also be emphasized that the previously described properties of the nonwoven fabric can be realized within the scope of the invention with little effort. This also applies in particular to the apparatus according to the invention and the method according to the invention.

The invention is explained in more detail hereinafter with reference to a drawing that merely represents an exemplary embodiment. In the figures in schematic representation:

FIG. 1 is a plan view of a nonwoven fabric according to the invention,

FIG. 2 is a cross-section along A-A of FIG. 1,

FIG. 3 is a vertical section through an apparatus according to the invention, and

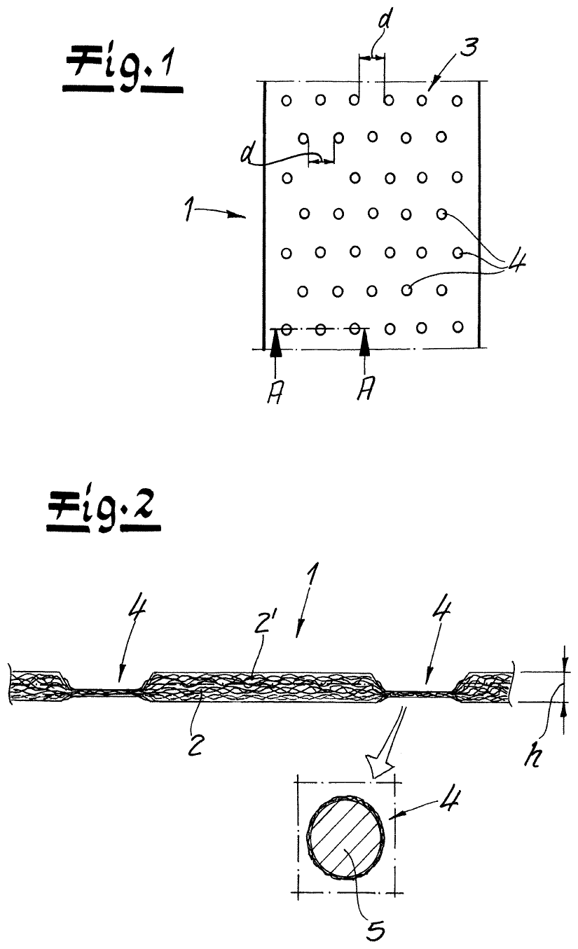

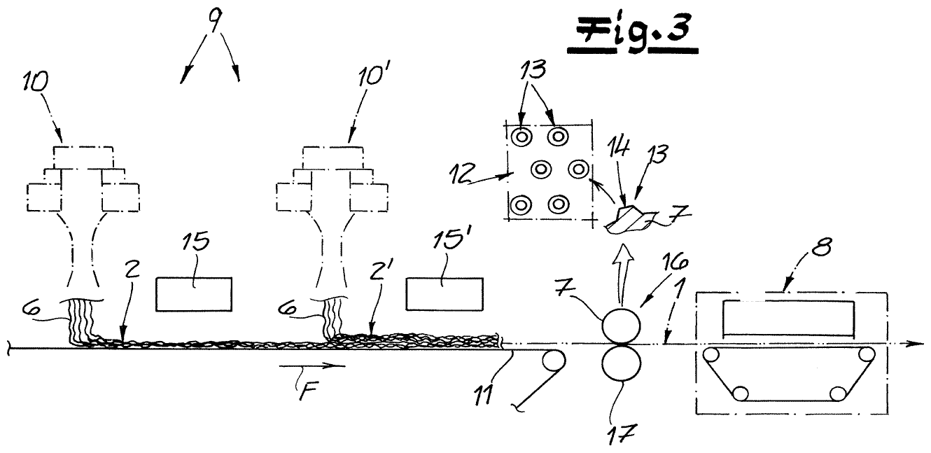

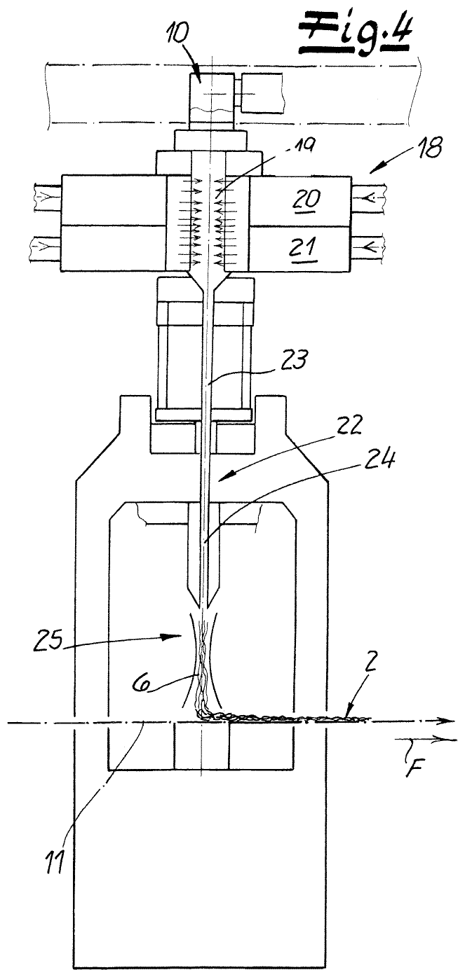

FIG. 4 is a vertical section through part of the device according to FIG. 3.

FIGS. 1 and 2 show a nonwoven fabric 1 according to the invention with at least one nonwoven web 2 of filaments. In this embodiment according to the figures, the nonwoven fabric 1 comprises two nonwoven webs 2, 2′ of continuous filaments 6 and is in particular a nonwoven laminate. The continuous filaments 6 may preferably and here comprise crimped continuous filaments 6. Preferably and here the nonwoven fabric 1 comprises a spunbonded nonwoven fabric with two spunbonded nonwoven webs 2, 2′ of crimped continuous filaments 6. In this embodiment, the crimped continuous filaments 6 may be bicomponent filaments with an eccentric core-sheath configuration, and the sheath of the continuous filaments 6 preferably consists of or substantially consists of polyethylene and the core of the continuous filaments 6 consists of or substantially consists in particular of at least one polyester and/or polypropylene.

FIGS. 1 and 2 further show that the nonwoven fabric 1 has an embossing pattern 3, where the embossing pattern 3 consists of a plurality of embossments 4 not connected to one another. “Embossment” means in particular a compacted location of the nonwoven fabric 1 where the nonwoven fabric 1 has a smaller thickness compared to the nonembossed regions and where the crimped continuous filaments 6 of the nonwoven fabric 1 are at least partially connected or fused to one another, preferably by the action of pressure and/or temperature. The embossing pattern 3 is preferably and here a regular embossing pattern 3, whose individual embossments 4 are preferably and here distributed across at regular spacings on the nonwoven fabric 1.

According to the invention, the embossments 4 each have an embossing area 5 of 0.05 to 0.3 mm². “Embossing area” 5 of an embossment 4 means, within the scope of the invention and here, in particular the embossed area of an embossment 4, wherein when determining the size of the embossing area 5, the material overhang or material projection possibly formed in the course of the pressing or embossing process and at least partially surrounding the embossment 4 is not part of the embossing area 5 of an embossment 4. This can be seen particularly in FIG. 2 by hatching. Further preferably and here, the embossing area 5 of the individual embossments 4 of the embossing pattern 3 is the same size or substantially the same size. Preferably and here according to the figures, the embossing areas 5 of the embossments 4 have a punctuate or circular geometry in plan view. Quite particularly preferably and here, the embossing pattern 3 has the same or same-size embossments 4 or substantially the same or same-size embossments 4 with a homogeneous distribution of embossments 4 of the same geometry or of substantially the same geometry.

Within the scope of the invention, the smallest spacing d between two embossments 4 of the embossing pattern 3 is in each case 0.6 to 2.5 mm. “Smallest spacing” d between two embossments 4 means in particular the smallest spacing d between two immediately adjacent embossments 4 of the embossing pattern 5, i.e. preferably the smallest spacing d between an embossment 4 and the embossment 4 of the embossing pattern 3 that is closest to it. In addition, the smallest spacing d between two embossments 4 refers in particular to the smallest spacing d between the embossing boundaries of two embossments 4, i.e. to the smallest spacing of the two embossments 4 along the interposed nonembossed area of the nonwoven fabric 1.

It is advantageous that the proportion of the total embossing area of the embossing pattern 3 to the total surface area of the nonwoven fabric 1 is 2 to 12%. In this context, the “total embossing area” of the embossing pattern 3 means in particular the sum of the embossing areas 5 of the embossing pattern 3. In the context of the invention, the “total surface area” of the nonwoven fabric 1 means in particular the entire nonwoven fabric surface area including the embossed and nonembossed areas

Further preferably, the aspect ratio of the embossing area 5 of the embossments 4 is less than 3, preferably less than 2. In this context, “aspect ratio” of the embossing area 5 means in particular the ratio of the greatest length or longitudinal extension of the embossing area 5 of an embossment 4 to the greatest width or width extension of an embossing area 5 of the embossment 4. In this embodiment according to the figures, in which the embossing areas 5 of the embossments 4 have a punctuate or circular geometry in plan view, the aspect ratio is thus equal to 1.

Expediently the thickness h of the nonwoven fabric 1 is 0.15 to 0.75 mm. In this embodiment according to the figures, the thickness h of the nonwoven fabric 1 may be approximately 0.4 mm. “Thickness h” means the greatest thickness or total thickness of the nonwoven fabric 1 transversely, in particular perpendicularly or substantially perpendicularly to its planar extension in the nonembossed areas of the nonwoven fabric 1. This can be seen particularly in FIG. 2.

The embossing pattern 3 of the nonwoven fabric that comprises a plurality of embossments 4 is characterized in the context of the invention in particular by the fact that due to the special configuration of the embossments 4 and the properties of the nonwoven fabric 1 the perceptibility of the embossing pattern 3 for the human eye is at least significantly reduced, so that a barely visible embossing pattern 3 of embossments 4 results.

FIG. 3 shows an apparatus 9 according to the invention for making a nonwoven fabric 1 described previously comprising two nonwoven webs 2, 2′ of crimped continuous filaments 6. The apparatus preferably and here has two spinning beams 10, 10′ that are preferably and here each adapted to produce a spunbonded nonwoven web 2, 2′ of crimped continuous filaments 6 in the form of bicomponent filaments. In addition, according to the preferred embodiment, an endlessly rotating foraminous belt 11 is provided for depositing the continuous filaments 6 to form the nonwoven web 2, 2′. According to the invention, the apparatus 9 includes the calender roller 7 for introducing the embossing pattern 3 into the nonwoven fabric 1. Preferably and here, the calender roller 7 is part of a calender 16 comprising a pair of calender rolls 7, 17. Preferably and here, a calender roller 7 of the calender 16 has a complementary embossing pattern 12 of embossing elements 13 that each have a pressing area 14 of 0.05 to 0.3 mm². “Pressing area 14” means in particular the area of the embossing elements 13 of the calender roller 7 provided of making the embossing area 5 of the embossments 4 of the nonwoven fabric 1. Preferably and here according to FIG. 3, the embossing elements 13 of the calender roller 7 are frustoconical and the pressing area 14 corresponds to the top surface of the truncated cone. The other or further calender roller 17 of the calender 16 is preferably and hers a smooth roller 17 with a smooth outer surface.

According to a particularly preferred embodiment and here, the device 9 comprises a hot-air main consolidater 8 that is preferably in the travel direction F of the nonwoven fabric 1 downstream of the calender roller 7 or downstream of the calender 16. Preferably, the hot-air main consolidater 8 is a hot-air oven. Expediently and here, the apparatus 9 further comprises two preconsolidaters in the form of hot-air preconsolidaters 15, 15′. The hot-air preconsolidaters 15, 15′ preferably and here are upstream in the travel direction F of the nonwoven fabric 1 of the calender roller 7 or upstream of the calender 16. Preferably, and here according to FIG. 3, the hot-air preconsolidaters 15, 15′ are each directly downstream of a respective spinning beam 10, 10′ for preconsolidating the deposited nonwoven web 2, 2′. A first hot-air preconsolidater 15 is preferably directly downstream of a first spinning beam 10 in the travel direction F of the nonwoven fabric 1, and is then followed by a second spinning beam 10′ that is located immediately downstream of the second hot-air preconsolidater 15′. The hot-air preconsolidaters 15, 15′ are preferably designed as hot-air knives and/or as hot-air fields.

Within the scope of the invention and here according to FIG. 3, a nonwoven web 2 composed of crimped continuous filaments 6 is first made by the first spinning beam 10 and deposited on the foraminous belt 11. The nonwoven web 2 is then preferably and here, preconsolidated by the hot-air preconsolidater 15. Thereafter, a second nonwoven web 2′ composed of crimped continuous filaments 6 is expediently made by the second spinning beam 10′ and deposited on the first nonwoven web 2. The second nonwoven web 2′ or the aggregate of the first nonwoven web 2 and the second nonwoven web 2′ is then recommendably preconsolidated with the second hot-air preconsolidater 15′ and subsequently preferably detached from the foraminous belt 11 and fed to the calender 16 comprising the calender roller 7. The calender roller 7 of the calender 16 introduces an embossing pattern 3 comprising a plurality of embossments 4 into the nonwoven fabric 1 and the nonwoven fabric 1 is expediently consolidated in the process. This is then preferably followed by the consolidation or main consolidation of the nonwoven fabric 1 by the at least one hot-air main consolidater 8.

FIG. 4 shows the basic structure of a part of the apparatus 9 according to the invention of making a nonwoven web 2 according to the spunbond method, comprising a spinneret or the spinning beam 10 for spinning the continuous filaments 6 for the spunbonded nonwoven web 2 of continuous filaments 6. The continuous filaments 6 spun by the spinneret or the spinning beam 10 are introduced into a cooler 18 with a cooling chamber 19. Preferably and here, air supply cabins 20, 21 one above the other on two opposite sides of the cooling chamber 19 are provided. Air at different temperatures is preferably introduced into the cooling chamber 19 from the air supply cabins 20, 21 one above the other.

It is recommended and here that a stretcher 22 for stretching the continuous filaments 6 is provided downstream of the cooler 18 in the filament-travel direction. Expediently and here, the stretcher 22 has an intermediate passage 23 that connects the cooler 18 to a stretching shaft 24 of the stretcher 22. Preferably and here, the subassembly comprising the cooler 18, the intermediate passage 23 and the stretching shaft 24 is a closed unit and apart from the supply of cooling air in the cooler 18, no further air is supplied from the outside into this subassembly.

Expediently and here, a diffuser 25, through which the continuous filaments 6 are guided, adjoins the stretcher 22 in the filament-travel direction. After passing through the diffuser 25, the continuous filaments 6 preferably and here are for example deposited on a receiving device, here on a foraminous belt 11. The foraminous belt 11 preferably and here is an endlessly rotating foraminous belt 11. It is within the scope of the invention that the foraminous belt 11 is permeable to air, so that process air can be sucked from below through the foraminous belt.

1. A nonwoven fabric comprising at least one nonwoven web of filaments, wherein the nonwoven fabric has an embossing pattern consisting of a plurality of embossments that each have an embossing area of 0.05 to 0.3 mm².

2. The nonwoven fabric according to claim 1, wherein the smallest spacing d between two embossments of the embossing pattern is in each case 0.6 to 2.5 mm.

3. The nonwoven fabric according to claim 1, wherein the proportion of the total embossing area of the embossing pattern to the total surface area of the nonwoven web is 2 to 12%.

4. The nonwoven fabric according to claim 1, wherein the embossing areas of the embossments in plan view have at least one geometry selected from the group: “punctuate or circular, elliptical, square, rectangular, diamond-shaped, polygonal, linear, wavy.”

5. The nonwoven fabric according to claim 1, wherein the aspect ratio of the embossing area of the embossments is less than 4.

6. The nonwoven fabric according to claim 1, wherein the filaments of the at least one nonwoven web are formed as crimped and continuous multicomponent filaments.

7. The nonwoven fabric according to claim 6, wherein the multicomponent filaments or bicomponent filaments have a first component that consists or substantially consists of at least one thermoplastic polyolefin material or the multicomponent filaments or bicomponent filaments have a second or further component that consists or substantially consists of at least one thermoplastic material.

8. The nonwoven fabric according to claim 6, wherein the crimped and continuous multicomponent filaments, are multicomponent filaments or bicomponent filaments with side-by-side configuration and/or with core-sheath configuration.

9. The nonwoven fabric according to claim 1, wherein the nonwoven fabric has a mass per unit area of less than 200 g/m².

10. The nonwoven fabric according to claim 1, wherein the nonwoven fabric has a thickness h of 0.1 to 0.85 mm.

11. The nonwoven fabric according to claim 1, wherein the nonwoven fabric has an abrasion resistance of at least Class 2 according to Martindale or the nonwoven fabric has a maximum flexural stiffness with a cantilever of at most 100 mm.

12. The nonwoven fabric according to claim 1, wherein the strength of the nonwoven fabric in the machine direction is at least 8 N/5 cm.

13. The nonwoven fabric according to claim 1, wherein the depth t of the embossments is 0.1 to 0.8 mm.

14. The nonwoven fabric according to claim 1, wherein the nonwoven fabric is a nonwoven laminate composed of at least two nonwoven webs or nonwoven fabric layers.

15. The nonwoven fabric according to claim 1, wherein the nonwoven fabric is consolidated with at least one calender roller for making the embossing pattern.

16. An apparatus for making a nonwoven fabric comprising at least one nonwoven web of filaments, the apparatus comprising:
at least one filament-making device for spinning and depositing filaments to form the nonwoven web on at least one foraminous belt;
at least one calender roller for introducing an embossing pattern comprising a plurality of embossments into the nonwoven fabric, the calender roller having a complementary embossing pattern comprising embossing elements that each have a pressing area of 0.05 to 0.3 mm².

17. The apparatus according to claim 16, wherein the apparatus further comprises at least one hot-fluid main consolidater.

18. The apparatus according to one of claims 16, wherein the apparatus further comprises at least one preconsolidater in the travel direction F of the nonwoven fabric upstream of the calender roller.

19. A method of making a nonwoven fabric comprising at least one nonwoven web of filaments, the method comprising the steps of:
making filaments with at least one filament-making device and subsequently depositing them on at least one foraminous belt to form the nonwoven web; and
subsequently consolidating the nonwoven web with at least one calender roller and introducing an embossing pattern comprising a plurality of embossments into the nonwoven web by the at least one calender roller such that the embossments each have an embossing area of 0.05 to 0.3 mm².

20. The method according to claim 19, wherein the nonwoven fabric, is consolidated by at least one hot-fluid consolidater.

21. The method according to claim 19, further comprising the step of:
preconsolidating the nonwoven web after deposition on the foraminous belt with at least one preconsolidater.

22. (canceled)
